(19) United States
(12) Patent Application Publication
(10) Pub. No.: US 2004/0257602 A1
(43) Pub. Date: Dec. 23, 2004

(54) Image forming apparatus and image forming condition displaying method

(75) Inventors: Shigeo Konuma, Tokyo (JP); Tadashi Tenda, Tokyo (JP); Kimikazu Saitoh, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA BUSINESS TECHNOLOGIES, INC.

(21) Appl. No.: 10/781,621

(22) Filed: Feb. 20, 2004

(30) Foreign Application Priority Data
Jun. 17, 2003 (JP) 2003-171849

(51) Int. Cl. G06F 15/00; G09G 5/00; G06F 3/12

(52) U.S. Cl. 358/1.13; 715/700

(57) ABSTRACT

An image forming apparatus includes: a display section for displaying an initial screen for performing function selection and a setting screen, which is displayed by performing the function selection a plurality of times from the initial screen, for performing a setting input of an image forming condition, wherein a short cut button for displaying the setting screen is displayed on the initial screen after when the setting input of the image forming condition is performed on the setting screen.

### BACKGROUND OF THE INVENTION

1. Field of the Invention

The present invention relates to an image forming apparatus and particularly to an image forming apparatus, in which a display section for displaying an image forming condition is used as an operational section, and relates to an image forming condition displaying method applied to the image forming apparatus.

2. Description of Related Art

In recent years, each of image forming apparatuses has had various functions. Therefore, to set an image forming condition, there is an image forming apparatus in which an operator is required to click a selected functional element such as a predetermined button or the like placed on a certain setting screen to call a setting screen of a lower hierarchy, and depending on the situation, to click a selected element such as a predetermined button or the like placed on the setting screen of the lower hierarchy to call a setting screen of a further lower hierarchy. In this case, there is a method of normally displaying an initial screen on which a frequently used function(s) can be selected. In this method, functions are selected one after another by starting from this initial screen, an image forming condition is set, and the initial screen is again displayed after the setting.

Therefore, depending on the image forming conditions there are many image forming apparatuses in which the setting of the image forming condition cannot be performed unless function selection is repeatedly performed to change many times display screens for operation and to reach a setting screen of a considerably lower hierarchy, and a setting operation is complicated. Particularly, when a content once set is set again, re-changing of display screens is required. Therefore, it is desired to eliminate troublesomeness of the setting operation.

In JP-Tokukai-2002-132099A, a technique is disclosed to eliminate troublesomeness of the setting operation by making in advance a short cut capable of proceeding to a display screen for setting a predetermined image forming condition set at high frequency, displaying the short cut on an initial display screen for setting, and making a user select this short cut to automatically change the initial display screen to the setting display screen of the image forming condition.

In JP-3141395B, a following technique is disclosed. That is, a function is selected on a screen having a hierarchy structure, and a parameter relating to an image forming condition is set on a displayed setting screen. Thereafter, when a setting confirmation button is pushed, a button relating to the function previously set is displayed. Thereafter, when the displayed button is pushed, a popped-up screen is displayed, and a parameter can be changed.

Incidentally, image forming apparatuses have been used for various purposes, and there are various types recording mediums used for the image forming apparatuses. Therefore, in practical use, the setting of conditions other than image forming conditions prescribed by the short cut has been increased.

However, in the technique of JP-Tokukai-2002-132099A, the short cut is managed by a specific manager, but a general user cannot change appropriately the short cut (paragraph “0027”).

Further, though it is preferred to make short cuts as many as possible, a displaying area of the short cuts is limited. Therefore, it is impossible that short cuts for image forming conditions desired by all users are made respectively and the short cuts are displayed on an initial display screen. Accordingly, operability is not sufficiently improved.

In JP-3141395B, though the button corresponding to the short cut is displayed, the button is displayed on a different screen called a set function confirmation screen. Therefore, it is required to troublesomely display another screen to use the short cut, and operability is not sufficient.

### SUMMARY OF THE INVENTION

Consequently, the present invention is provided in the view of the above-mentioned problems. An object of the present invention is to provide an image forming apparatus in which a setting screen of an image forming condition is displayed by performing function selection a plurality of times, for example, an image forming apparatus capable of improving operability by making possible the setting of a hierarchically managed image forming condition without changing any screen, and a displaying method of the image forming condition which is appropriately used for the image forming apparatus.

In order to accomplish the above-mentioned object, in accordance with a first aspect of the present invention, an image forming apparatus comprises:

a display section for displaying an initial screen for performing function selection, and a setting screen for performing a setting input of an image forming condition, the setting screen being displayed by performing the function selection a plurality of times from the initial screen,

wherein a short cut button for displaying the setting screen is displayed on the initial screen after when the setting input of the image forming condition is performed on the setting screen.

According to the invention of the first aspect, the image forming apparatus comprises the display section for displaying the initial screen for performing the function selection, and the setting screen displayed by performing the function selection a plurality of times from the initial screen. The setting screen is the screen for performing the setting input of the image forming condition.

A user performs the setting input of an image forming condition according to the setting screen of the display section.

Thereafter, a short cut button for displaying a selected setting screen is displayed on the initial screen according to the setting input of the condition performed by the user.

Accordingly, the setting of the image forming condition which is hierarchically managed can be performed without changing any screen, and operability can be improved.

Preferably, image formation is performed by using image data, and the image forming condition is an image processing condition corresponding to the image data.

According to the present invention, the setting of the image forming condition corresponding to the image data in which various types settings exist can be easily performed.

Preferably, the image forming condition is a post-processing condition.

According to the present invention, the setting of the post-processing condition in which the various types settings exist can be easily performed. In this invention, the post-processing conditions denote processing conditions of recording paper after making an image on the recording paper. The post-processing conditions are, for example, staple processing, punch processing and the like.

Preferably, the plurality of short cut buttons are displayed in a list.

According to the present invention, when the number of set matters is increased, a user can easily confirm the short cut buttons by displaying the short cut buttons in a list. Accordingly, operability can be further improved.

Preferably, the plurality of short cut buttons are displayed in a list according to a frequency of use.

According to the present invention, when the number of set matters is increased, a user can easily confirm the short cut buttons by displaying the short cut buttons in a list according to frequency of use of the user, and operability can be further improved.

Preferably, the plurality of short cut buttons are displayed in a condition that the plurality of short cut buttons are capable of being scrolled or turned over.

According to the present invention, when the number of set matters is increased, many short cut buttons for screens corresponding to each of the set matters can be displayed in a narrow area, by displaying the plurality of short cut buttons, in a condition that the plurality of short cut buttons are capable of being scrolled or turned over. Further, a user can easily confirm the short cut buttons, and operability can be further improved.

Preferably, information relating to a set content of the short cut button is displayed on the initial screen.

According to the present invention, a user can confirm information relating to the set content of the image forming condition set by himself or herself without watching the setting screen, by displaying information relating to the set content of each short cut button. Accordingly, operability can be further improved.

Preferably, the set content of the short cut button is the selected function.

According to the present invention, a user can confirm the function selected by himself or herself without watching the setting screen, by displaying information relating to the set content of each short cut button. Accordingly, operability can be further improved.

Preferably, the set content of the short cut button is the image forming condition of which the setting input is performed.

According to the present invention, a user can confirm the information relating to a set content of the image forming condition set by himself or herself without watching the setting screen, by displaying information relating to the set content of each short cut button. Accordingly, operability can be further improved.

Preferably, the image forming apparatus further comprises a memory for storing screen information of the setting screen at a time of performing the setting input of the image forming condition.

According to the present invention, the initial screen including the short cut button for calling the setting screen of the image forming condition once set can be stored in the memory. Accordingly, the initial screen can be easily reproduced, and operability can be further improved.

Preferably, a read button for reading out the screen information stored in the memory is displayed on the initial screen.

According to the present invention, the initial screen stored in the memory can be called by clicking the read button displayed in the display section. Then, the combination of the image forming conditions performed in the past can be reproduced by reproducing the initial screen. Accordingly, operability can be further improved.

In order to accomplish the above-mentioned object, in accordance with a second aspect of the present invention, an image forming condition displaying method comprises:

displaying an initial screen for performing function selection;

displaying a setting screen for performing a setting input of an image forming condition by performing the function selection a plurality of times from the initial screen; and

displaying a short cut button for displaying the setting screen on the initial screen when the setting input of the image forming condition is performed on the setting screen.

According to the present invention of the second aspect, the initial screen for performing the function selection is displayed, and the setting screen for performing the setting input of the image forming condition is displayed by performing function selection a plurality of times from the initial screen. Thereafter, a user performs the setting input of the image forming condition on this setting screen. A short cut button for displaying the setting screen is displayed on the initial screen after when the setting input of the image forming condition is performed on the setting screen. The user performs the setting of the image forming condition in an operational section according to this displayed screen of the display section.

Accordingly, the setting of an image forming condition which is hierarchically managed can be performed without changing any screen, and operability can be further improved.

Preferably, in the displaying of the short cut button, the short cut buttons are displayed in a list.

According to the present invention, when the number of set matters is increased, a user can easily confirm the short cut buttons by displaying the short cut buttons in a list, and operability can be further improved.

Preferably, in the displaying of the short cut button, an area where the short cut button is displayed is displayed in a condition that the area is capable of being scrolled or turned over.

According to the present invention, when the number of set matters is increased, many short cut buttons for screens corresponding to the set matters can be displayed in a narrow area by displaying the short cut button, in a condition that the area is capable of being scrolled or turned over. Further, a user can easily confirm the short cut buttons, and operability can be further improved.

Preferably, in the displaying of the short cut button, information relating to a set content of the short cut button is displayed with the short cut button.

According to the present invention, a user can confirm the image forming condition set by himself or herself without watching the setting screen of the condition by displaying the image forming condition, which corresponds to each short cut button, on the short cut button. Accordingly, operability can be further improved.

Preferably, the set content of the short cut button is the selected function.

According to the present invention, a user can confirm the function selected by himself or herself without watching the setting screen by displaying the information relating to the set content of each short cut button. Accordingly operability can be further improved.

Preferably, the set content of the short cut button is the image forming condition of which the setting input is performed.

According to the present invention, a user can confirm the information relating to the set content of the image forming condition set by himself or herself without watching the setting screen by displaying the information relating to the set content of each short cut button. Accordingly, operability can be further improved.

Preferably, screen information of a screen at a time that the setting input of the image forming condition is performed, is stored in a memory.

According to the present invention, the initial screen including the short cut button for calling the setting screen of the image forming condition once set can be stored in the memory. Accordingly, this initial screen can be easily reproduced, and operability can be further improved.

Preferably, on the initial screen, display is performed according to the screen information stored in the memory.

According to the present invention, the initial screen stored in the memory can be called to the display section. Then, the combination of image forming conditions performed in the past can be reproduced by reproducing this initial screen. Accordingly, operability can be further improved.

### BRIEF DESCRIPTION OF THE DRAWINGS

The present invention will become more fully understood from the detailed description given hereinbelow and the accompanying drawing which are given by way of illustration only, and thus are not intended as a definition of the limits of the present invention. Wherein:

FIG. 1 is a block diagram showing an embodiment of an image forming apparatus according to the present invention;

FIG. 2 is a view showing an example of a screen displayed at a time of a setting input of an image forming condition in the embodiment;

FIG. 3 is a view showing an example of a screen displayed at a time of a setting input of an image forming condition in the embodiment;

FIG. 4 is a view showing an example of a screen displayed at a time of a setting input of an image forming condition in the embodiment;

FIG. 5 is a view showing an example of a screen displayed at a time of a setting input of an image forming condition in the embodiment;

FIG. 6 is a view showing an example of a screen displayed at a time of a setting input of an image forming condition in the embodiment;

FIG. 7 is a view showing an example of a screen displayed at a time of a setting input of an image forming condition in the embodiment;

FIG. 8 is a view showing an example of a screen displayed at a time of a setting input of an image forming condition in the embodiment; and

FIG. 9 is a flow chart for explaining a displaying method of the embodiment as a displaying method according to the present invention.

### PREFERRED EMBODIMENTS OF THE INVENTION

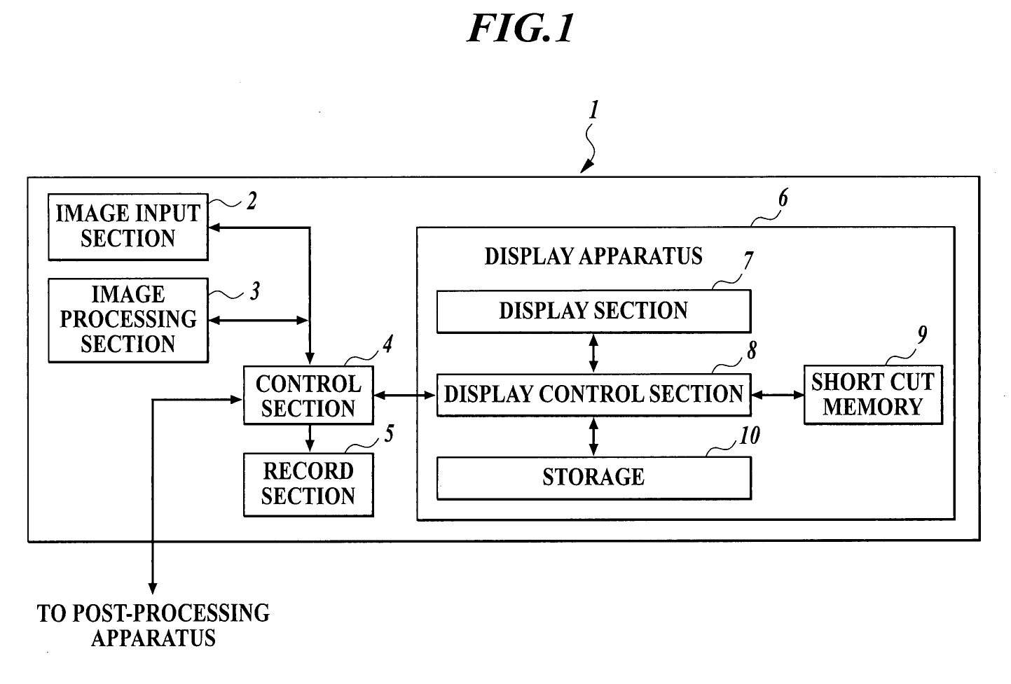

Hereinafter, an embodiment of the present invention will be explained with reference to FIGS. 1 to 9.

FIG. 1 is a block diagram showing an image forming apparatus according to an embodiment of the present invention. In an image forming apparatus 1, an image input section 2 for inputting image data is connected to an image processing section 3 for performing image processing for the inputted image data (named “input image data”), and connected to a control section 4 for controlling an operation of the image processing section 3, and the input image data is transmitted to the image processing section 3 and the control section 4. The image input section 2 is the section for producing and outputting the input image data, such as a scanner, a computer system operated according to a predetermined program for performing image formation or the like.

The image processing section 3 is the section for taking out information relating to an image of the input image data, performing predetermined image processing for the information, and producing recording image data to be processed in a record section 5 for performing image formation. The produced recording image data is transmitted to the control section 4.

The control section 4 is connected to the image input section 2, the image processing section 3, the record section 5 and a display section 6 for displaying an image forming condition(s) and performing a setting input of each condition. The control section 4 requires input image data of the image input section 2, takes out information relating to a process from the transmitted input image data, and controls the record section 5 and a post-processing apparatus (not shown) such as a finisher or the like according to the information. Further, the control section 4 transmits data relating to an image processing condition, which is required in correspondence to the image forming condition set in the display apparatus 6, to the image processing section 3. Moreover, the control section 4 transmits the recording image data, which is transmitted from the image processing section 3 after the image processing, to the record section 5. Further the control section 4 controls the record section 5 to record the image data.

The image forming condition is a condition for forming an image, and denotes a condition of processing performed in the image input section 2, the image processing section 3, the record section 5 and the post-processing apparatus.

The record section 5 forms an image from the recording image data transmitted from the image processing section 3 through the control section 4, according to the information relating to the process transmitted from the control section 4.

In the display apparatus 6, a display section 7 is connected to a display control section 8 and performs a display according to display data relating to the image forming condition transmitted from the display control section 8. Further, the display section 7 can perform both a display operation and an operation of an operating section performing a setting operation, for example, like a touch panel. Therefore, the display section 7 can perform a setting input in addition to a display relating to the image forming condition. When a setting input is performed to the display section 7, the display section 7 transmits data indicating the setting input to the display control section 8.

The display control section 8 is connected to the display section 7 and a storage 10. When an operation for changing a screen is performed in the display section 7, the display control section 8 takes out display data corresponding to the operation from the storage 10 and transmits the display data to the display section 7. Further, the display control section 8 is also connected to the control section 4. When data relating to a setting input is transmitted from the display section 7 to the display control section 8, the display control section 8 transmits this data as data relating to an image forming condition. Moreover, the display control section 8 is also connected to the display section 7 and a short cut memory 9. To immediately read out a setting screen of an image forming condition set differently from a default, the display control section 8 makes a short cut for reading out display data corresponding to the setting screen, and transmits the short cut to the display section 7 and the short cut memory 9.

The short cut memory 9 accumulates image data for reproducing a display screen of the display section 7 including the short cut button made in the display control section 8.

In addition, the storage 10 stores display data to be displayed in this display section 7.

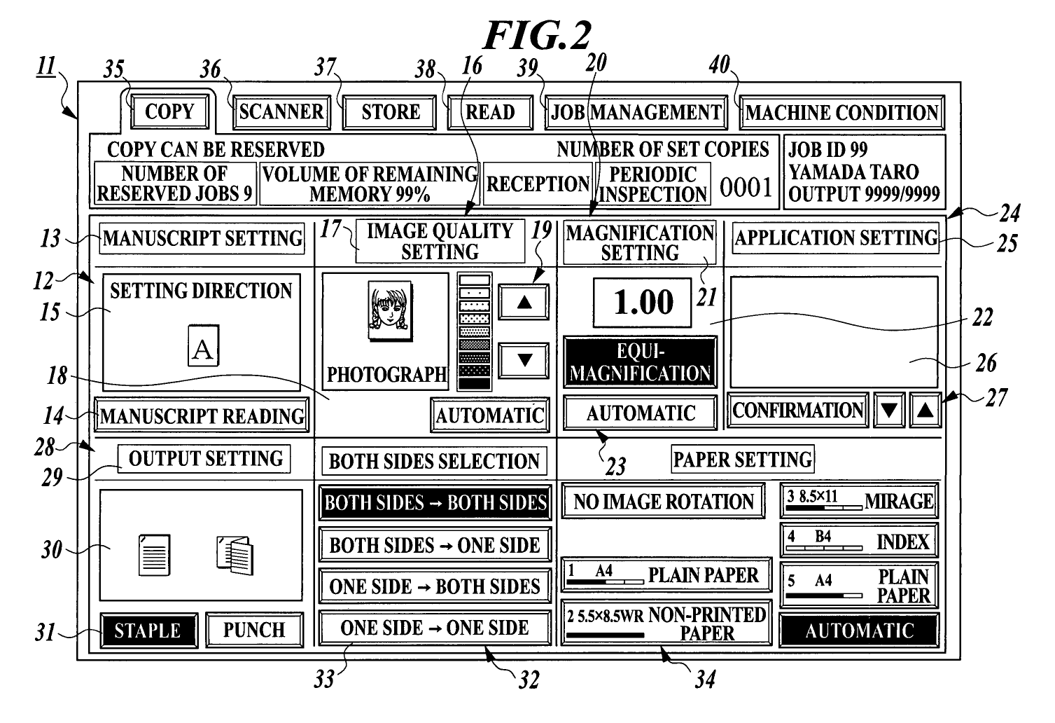

FIG. 2 shows an initial screen based on one of pieces of display data stored in the storage 10. The initial screen is a screen for displaying fundamental functions, denoting functions frequently used and relating to image formation, such as the setting of magnification, the setting of density and the like. For example, a screen 11 is provided with a manuscript setting area 12 for performing the setting relating to the reading of a manuscript, an image quality setting area 16 for performing the setting relating to image quality, a magnification setting area 20 for setting magnification, an application setting area 24 for setting other image forming conditions, an output setting area 28 for setting post-processing performed after the outputting from the record section 5 is performed, a both-sides selection area 32 for specifying the recording surfaces (both sides or one side) of a manuscript and a recording medium after recording, and a paper setting area 34 for setting a condition of a paper denoting the recording medium.

Further, the display section 3 also acts as an operational section for performing selection of these displayed functions.

The manuscript setting area 12 is provided with a manuscript setting button 13 for calling a manuscript setting menu screen for setting a feeding direction of a manuscript and the like, a manuscript reading button 14 for instructing to actually read the manuscript, and a monitor area 15 for visualizing a set condition.

The image quality setting area 16 is provided with an image quality setting button 17 for calling an image quality setting menu screen for setting a type of a manuscript, detailed light and shade and the like, a monitor area 18 for visualizing a set condition, a light and shade setting button group 19 for setting only light and shade.

The magnification setting area 20 is provided with a magnification setting button 21 for calling a magnification setting menu screen for setting magnification in detail, a monitor area 22 for displaying the set magnification, and a simple magnification setting button group 23 for simply setting magnification.

The application setting area 24 is provided with an application setting button 25 for calling an application setting menu screen of various image forming conditions. In the present embodiment, the application setting area 24 is further provided with a short cut display area 26 for displaying short cut buttons described later, and an application setting operational button group 27 for performing a screen operation of the short cut display area 26 or the like.

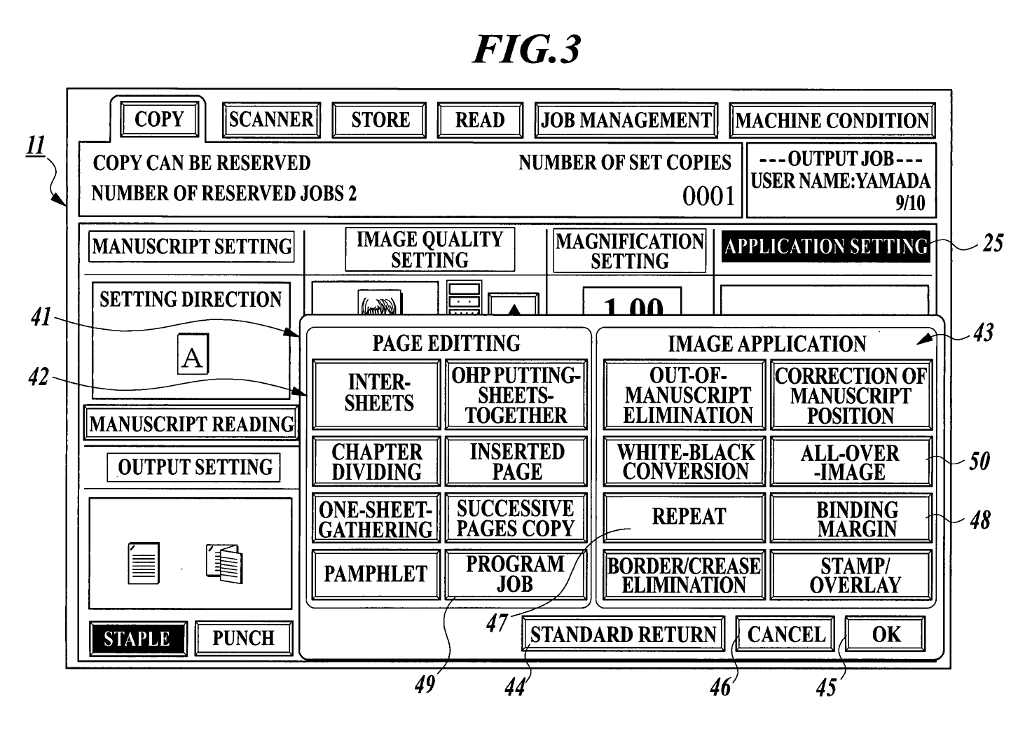

FIG. 3 is a view showing an example of an application setting menu screen. An application setting menu screen 41 is the screen which is popped up on the screen 11, when an application function is selected by clicking the application setting button 25. The application setting menu screen 41 is provided with a page editing button group 42 for calling a setting screen for page editing, and an image application button group 43 for calling a setting screen for image application processing.

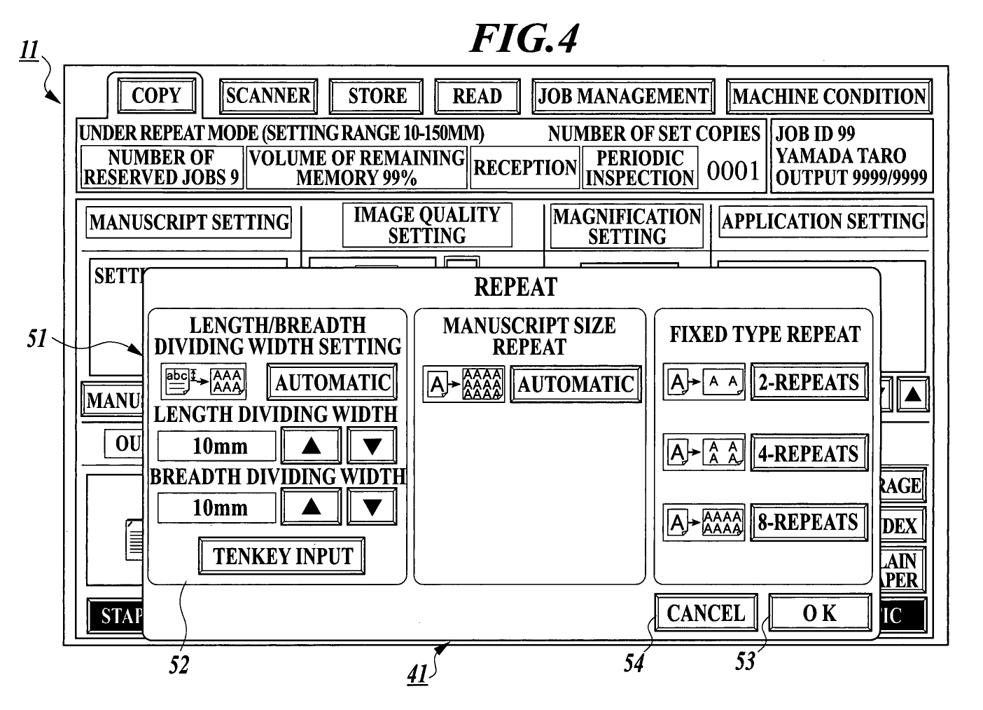

FIG. 4 is a view showing an example of a repeat setting screen called when a repeat button 47 in FIG. 3, for example, is clicked in order to select a repeat setting function for repeatedly recording one content. The repeat setting screen 51 is the screen which is popped up on the application setting menu screen 41. The repeat setting screen 51 is provided with a setting area 52 for performing a detailed setting, an OK button 53 for reflecting a set content in all over image forming apparatus, and a cancel button 54 for canceling the set content.

As described above, the application function is selected from the initial screen 11, and the repeat setting function is selected from the displayed application setting menu screen 41. As a result, the repeat setting screen 51 denoting a setting screen is displayed. The other functions such as the binding margin and the like are selected in the same manner. Thus, a setting screen for performing the setting input of an image forming condition is displayed by performing function selection a plurality of times.

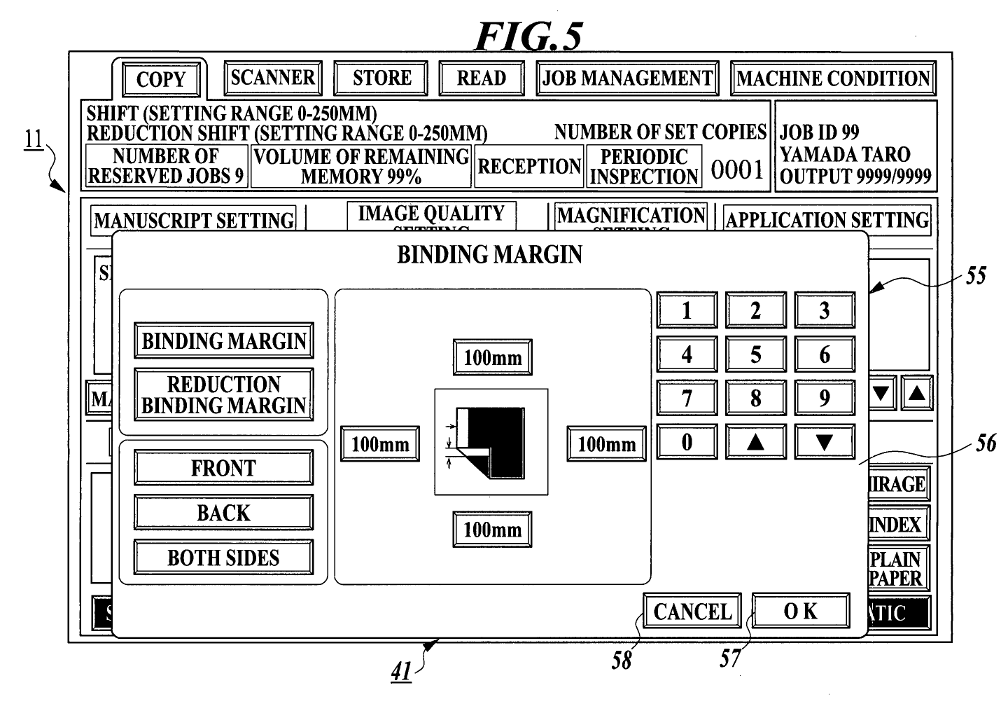

FIG. 5 is a view showing an example of a binding margin setting screen 55 called when a binding margin button 48 in FIG. 3, for example, is clicked in order to perform the setting of making a binding margin during the recording to the recording medium. The binding margin setting screen 55 is the screen which is popped up on the application setting menu screen 41. The binding margin setting screen 55 is provided with a setting area 56 for performing a detailed setting, an OK button 57 for reflecting a set content in all over image forming apparatus, and a cancel button 58 for canceling the set content.

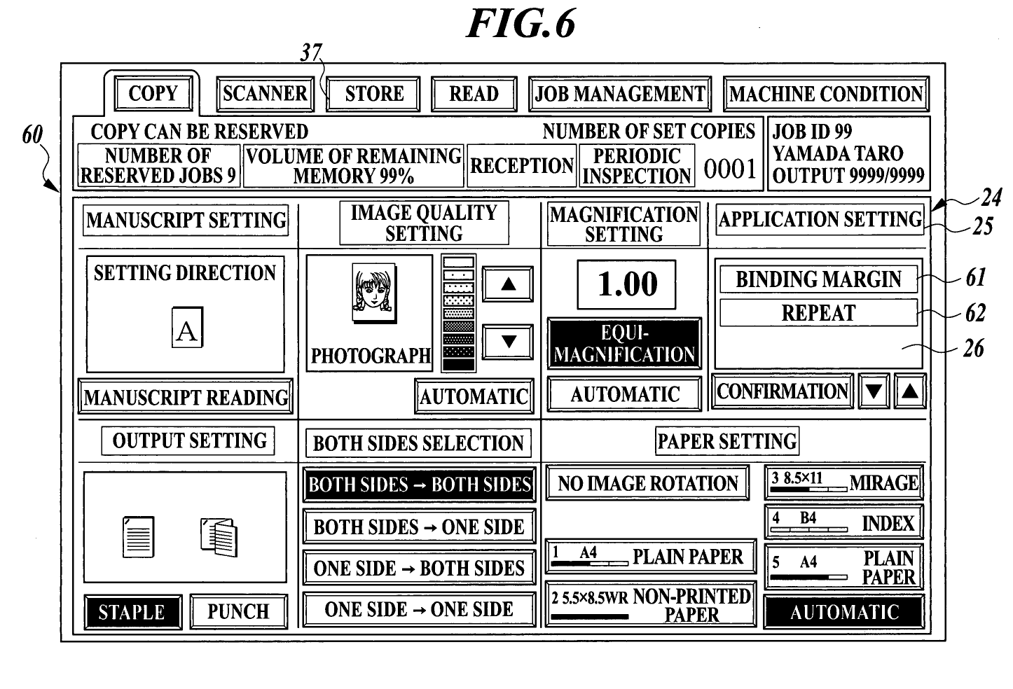

FIG. 6 is a view showing an example of a screen displayed in the display section 7 after the repeat setting screen and the binding margin setting screen shown in FIG. 4 and FIG. 5 are called and the predetermined setting is performed. A short cut button for calling a setting screen of a parameter set in detail is displayed on the short cut display area 26 arranged in the application setting area 24 of a screen 60. In FIG. 6, a short cut button 61 for calling a setting screen for setting a binding margin and a short cut button 62 for calling a setting screen for setting a repeat, are displayed. When each of the short cut buttons 61 and 62 is clicked, the corresponding setting screen is popped up and displayed, for example, on the screen 60. In the present embodiment, a selected function such as a binding margin, a repeat or the like is displayed with a short cut key. Though not shown in any figure, parameters actually set may be displayed on these short cut buttons 61 and 62 (hereinafter, in the same manner). An operator can easily confirm the set content, for example, in the case of the repeat function, by displaying the set content such as 2 repeats, 5 repeats in FIG. 4 or the like with the short cut keys, or in case of the binding margin, by displaying the set content such as a reduction binding margin, a size of binding margin in FIG. 5 or the like with the short cut keys. Further, when the application setting is performed, the application setting button 25 is clicked.

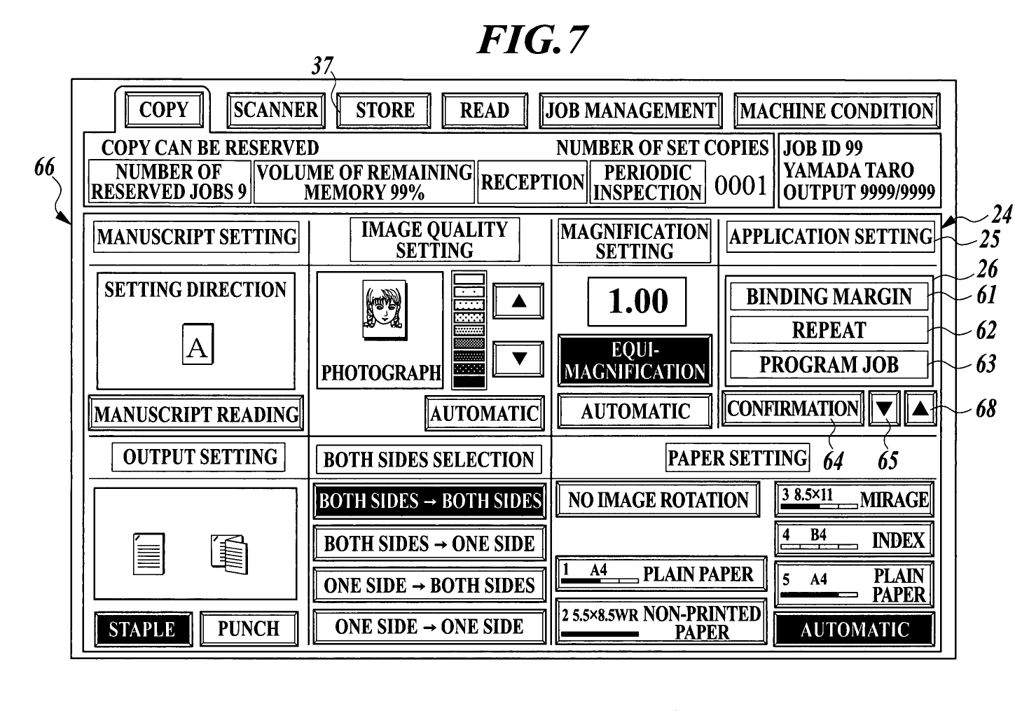

FIG. 7 is a view showing an example of a screen displayed in the display section 7 after the setting of a program job, which is set when jobs read as a memory copy are finally output together, is performed, in addition to the binding margin setting for setting an amount of shift at the time of making a binding margin by shifting or reducing an image, and the repeat setting for setting X and Y widths of an image at the time of repeatedly copying the same image to a piece of paper. In the short cut display area 26 arranged in the application setting area 24 of a screen 66, a short cut button 63 for calling a setting screen for setting a program job is displayed in addition to the short cut buttons 61 and 62. Further, below the short cut display area 26, there are provided a confirmation button 64 for calling a screen indicating a content set on a setting screen displayed by each short cut button, and scroll buttons 65 and 68 for scrolling a screen when short cut buttons are excessively made not to be able to be displayed on the short cut display area 26.

As described above, a plurality of settings can be easily confirmed by displaying a plurality of short cut keys on the initial screen 11 in a list. This list display can be performed according to the frequency of use of each short cut key. For example, when the short cut keys are displayed in a display area from the top in order of decreasing the frequency of use (or the number of times) of the function, a user can use the short cut keys more easily. The display of the short cut keys in the order of the frequency of use can be renewed (or interchanged) according to the number of times of use.

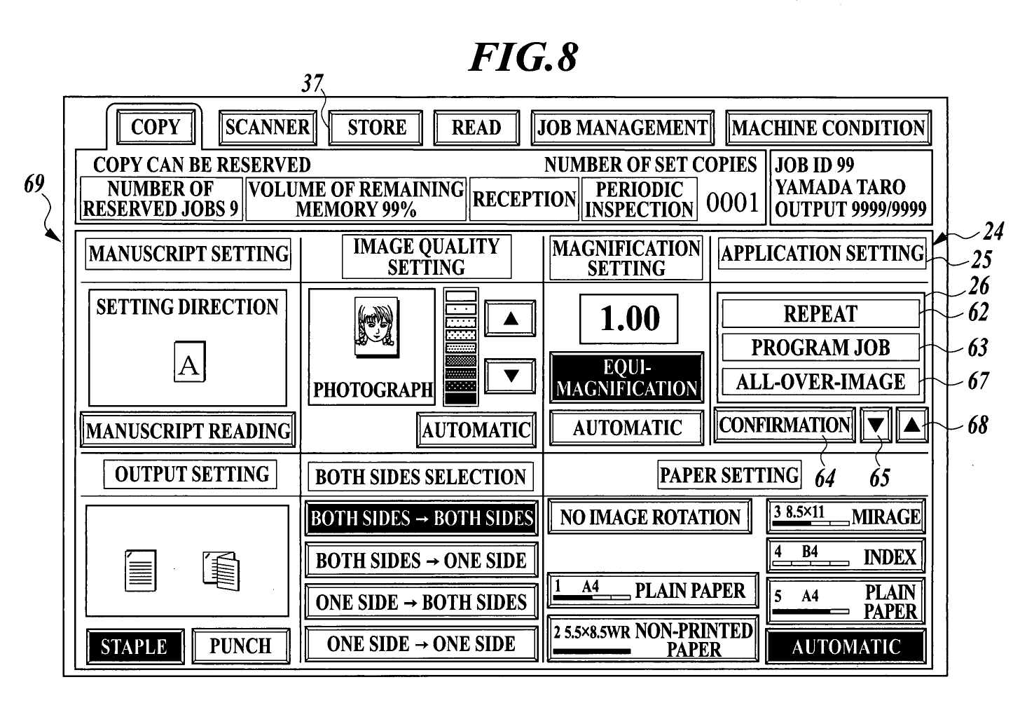

FIG. 8 is a view showing an example of a screen displayed in the display section 7 after the allover image setting is performed, in addition to the binding margin setting, the repeat setting and the program job setting. In the short cut display area 26 arranged in the application setting area 24 of a screen 69, a short cut button 67 for calling a setting screen for setting an allover image is displayed, in addition to the short cut buttons 62 and 63. Further, in the same manner as that described above, below the short cut display area 26, there are provided the confirmation button 64 for calling the screen indicating the content set in the setting screen displayed by each short cut button, and the scroll buttons 65 and 68 for scrolling the screen when short cut buttons are excessively made not to be able to be displayed on the short cut display area 26.

Returning to FIG. 2, in the output setting area 28, there are provided an output setting button 29 for calling a post-processing setting menu screen for setting post-processing for a recording medium after recording, a monitor area 30 for visualizing a set condition, and a direct call button group 31 for directly selecting and calling staple processing or punch processing as representative post-processing.

Though not shown in any figure, in the staple processing, it is possible that a function selection screen for selecting a one-position staple, a plural-of-positions staple or the like is further arranged on a next screen. In addition, it is possible that a setting screen for setting a position of the staple(s) displayed by this selection is displayed.

In the both-sides selection area 32, there are provided a recording plane selection button group 33 for selecting the recording surfaces of the manuscript and the recording medium after the recording, in other words, selecting the condition of manuscript recording surface, from “BOTH SIDES→BOTH SIDES”, “BOTH SIDES→ONE SIDE”, “ONE SIDE→BOTH SIDES” or “ONE SIDE→ONE SIDE”.

In the paper setting area 34, there are provided areas for displaying a size, a type, a remaining volume and the like of recording mediums available for putting into each feeding tray.

On the upper area of the screen 11, there are provided a button group for setting an operation mode of the screen display. In detail, there are provided a copy button 35 for selecting an operation mode for setting a copy type, a scanner button 36 for selecting an operation mode for setting an operation condition of a scanner (a reading apparatus), a store button 37 for selecting an operation mode for storing a screen, which is once displayed, in a short cut memory 9, a read button 38 for selecting an operation mode for reading out a screen from the short cut memory 9, a JOB management button 39 for selecting an operation mode for managing a job and, a machine condition button 40 for selecting an operation mode for managing a condition of the image forming apparatus.

In the storage 10, in addition to the initial display screen 11 shown in FIG. 2, display data for displaying each menu screen described before, a menu screen of a hierarchy lower than that of each menu screen described before, setting screen of each condition, a screen for selecting the completion or non-completion of a setting input, a screen for selecting the storage or non-storage of a screen including a short cut button(s) once displayed and the like, are stored.

Next, the setting of an application function will be described as an example of the operation according to the present embodiment.

Input image data transmitted from the image input section 2 is transmitted to the image processing section 3 and the control section 4. In the image processing section 3, information relating to image is taken out from the input image data. In the control section 4, information relating to a process is taken out from the input image data.

At this time, in the display apparatus 6, for example, the initial screen 11 shown in FIG. 2 is displayed in the display section 7, and a setting input of an image forming condition is performed by a user according to this display.

On this initial screen 11, when the application setting button 25 is clicked by the user, the application setting menu screen 42 shown in FIG. 3 is popped up.

On the application setting menu screen 42, for example, when the repeat button 47 is clicked, the repeat setting screen 51 shown in FIG. 4 is further popped up, and the repeat setting is performed. When the OK button 53 is clicked, a set parameter is transmitted from the display control section 8 in FIG. 1 to the control section 4, the repeat setting screen 51 is closed, and the display again returns to the application setting menu screen 41 shown in FIG. 3. In contrast, when the cancel button 54 is clicked, the repeat setting screen 51 is closed without any other operations, and the display again returns to the application setting menu screen 41 shown in FIG. 3.

Further, for example, on the application setting menu screen 42, when the binding margin button 48 is clicked, the binding margin setting screen 55 shown in FIG. 5 is further popped up, and the binding margin setting is performed. When the OK button 57 is clicked, a set parameter is transmitted from the display control section 8 in FIG. 1 to the control section 4, the binding margin setting screen 55 is closed, and the display again returns to the application setting menu screen 41 shown in FIG. 3. In contrast, when the cancel button 58 is clicked, the binding margin setting screen 55 is closed without any other operations, and the display again returns to the application setting menu screen 41 shown in FIG. 3.

As described above, the setting desired by the user is performed. Thereafter, when an OK button 45 is clicked, the application setting menu screen 41 is closed. Accordingly, the short cut button 61 relating to the binding margin setting and the short cut button 62 relating to the repeat setting are displayed in the short cut display area 26 of the application setting area 24, as shown in FIG. 6. In contrast, when a cancel button 46 is clicked, the display returns to the screen displayed before the application setting operation. Accordingly, when a standard return button 44 is clicked, data indicating the returning to the condition of the default setting is transmitted from the display control section 8 to the control section 4 in FIG. 1. Further, the display returns to the screen displayed before the application setting operation.

In this embodiment, the OK buttons 45, 53 and 57 are described as an example. However, it is applicable that “CLOSE” buttons be arranged in place of the OK buttons 45, 53 and 57 to have the same function as that of the OK buttons 45, 53 and 57.

An operation for the display of this short cut button will be described.

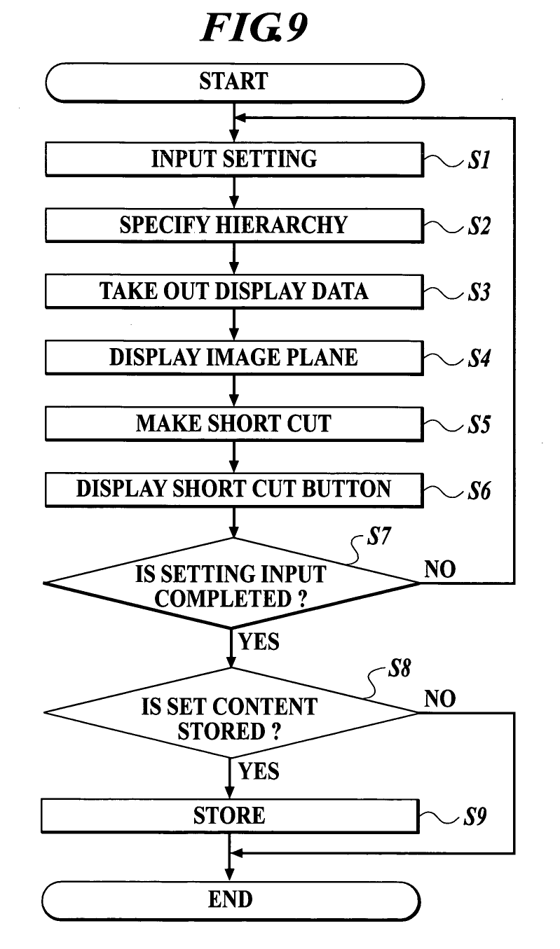

FIG. 9 is a flow chart explaining this operation. An operation for calling a setting screen for performing a setting input of a desired parameter is performed by a user by performing function selection a plurality of times from the initial screen (step S1). Thereafter, a hierarchy of this setting screen, that is, a hierarchy in a structure composed of all screens called to call the setting screen is specified by the display control section 8 (step S2).

Thereafter, the display control section 8 takes out display data relating to the setting screen of the hierarchy specified from the storage 10 (step S3). Accordingly, the display control section 8 transmits the display data to the display section 7, and makes the display section 7 display the setting screen (step S4).

As described before, the user performs the setting of a predetermined parameter by performing an operation for this screen. When the OK button is finally clicked, each short cut button 61 (and 62) for calling a setting screen called for the setting is made by the display control section 8 (step S5).

Thereafter, the display control section 8 transmits the made short cut button to the display section 7. In the display section 7, as described above, these short cut buttons 61 and 62 are displayed on the initial screen (step S6).

Thereafter, the display control section 8 reads out a screen, which urges the user to input the completion or non-completion of a setting input, from the storage 10. Accordingly, the display control section 8 transmits the screen to the display section 7, makes the display section 7 display the screen. Further, the display control section 8 judges whether or not the setting input is completed, according to the input by the user (step S7).

When the judging result indicates NO, that is, when the user decides to continue the setting input and performs the input accordingly, the procedure returns to the setting input processing (step S1). As. shown in FIGS. 7 and 8, the short cut buttons 63 and 67 are added one by one to the short cut display area 26 by repeating the setting input processing (step S1), the hierarchy specifying processing (step S2), the display data reading out processing (step S3), the image display processing (step S4), the short cut making processing (step S5) and the short cut button display processing (step S6).

When the judging result indicates YES, that is, when the user decides to finish the setting input and performs the input accordingly, the display control section 8 reads out display data, which relates to a screen for selecting the storage or non-storage of a screen including a short cut button(s) once displayed, from the storage 10. Accordingly, the display control section 8 transmits the display data to the display section 7, and makes the display section 7 display the screen. Further, the display control section 8 judges whether or not a set content is stored (step S8), according to the input by the user.

When the judging result indicates YES, that is, it is judged that the user desires to store the set content, for example, when the store button 37 in FIG. 2 is clicked, the display control section 8 transmits this content to the short cut memory 9. In the short cut memory 9, image data for reproducing a display screen of the display section 7 including a short cut button(s) made in the display control section 8 is stored (step S9), and the setting operation of a parameter is completed. When the judging result indicates NO, that is, it is judged that the user desires not to store the set content, the setting operation of a parameter is ended.

As to data stored in the short cut memory 9, for example, when the read button 38 in FIG. 2 is clicked, the display control section 8 takes out desired image data from the short cut memory 9, and an operational screen based on this image data is displayed in the display section 7.

In the same manner, the manuscript setting, the image quality setting, the magnification setting, the output setting, the both-sides selection setting and the like are performed by clicking the buttons 13, 17, 21, 29 and 32 and calling predetermined screens.

When an image forming condition is set as described above, data relating to the image forming condition is transmitted from the display control section 8 of the display apparatus 6 to the control section 4. Accordingly, the control section 4 transmits the data relating to the image forming condition to the image processing section 3 and controls the image processing section 3 to perform the image processing at this condition. The image processing section 3 performs the image processing of the inputted image data according to data relating to the transmitted image forming condition. The obtained recording image data is transmitted to the control section 4.

The control section 4 transmits this transmitted recording image data to the record section 5. In the record section 5, the image data is recorded to a recording medium according to the inputted image data, or depending on the occasion, according to information relating to a process set in the display apparatus 6.

As described above, in the present embodiment, the setting of the image forming condition, which is hierarchically managed, in other words, structured to be performed after the performance of function selection a plurality of times, can be performed without changing the screen, and operability can be improved.

Further, when the number of set matters is increased, the user can easily confirm the short cut buttons, by displaying the short cut buttons in a list in the short cut display area 26 denoting a predetermined area of the display section 7. Accordingly, operability can be further improved. Moreover, the user can further easily use the short cut buttons by performing the list display according to frequency of use.

Moreover, when the number of set matters is increased, many short cut buttons for screens corresponding to each of the set matters can be displayed in a narrow area, by displaying the plurality of short cut buttons, in a condition that the plurality of short cut buttons are capable of being scrolled or turned over by arranging the scroll buttons 65 and 68. Further, a user can easily confirm the short cut buttons, and operability can be further improved.

It is preferred that information relating to a set content be displayed with each short cut button. Further, it is preferred that a function for selecting this display or a corresponding image forming condition be displayed. Therefore, the user can confirm the image forming condition set by himself or herself without seeing a setting screen of the condition. Accordingly, operability can be further improved.

Further, by allowing that the initial screen including the short cut button for calling the setting screen of the image forming condition once set is stored in the short cut memory 9, the initial screen can be easily reproduced. Accordingly, operability can be further improved.

Moreover, the initial screen stored in the short cut memory 9 can be called by clicking the read button 38 displayed in the display section 7. Accordingly, the combination of image forming conditions performed in the past can be reproduced by reproducing this initial screen, and operability can be further improved.

The entire disclosure of Japanese Patent Application Publication No. Tokugan 2003-171849 filed on Jun. 17, 2003 including specification, claims, drawings and summary are incorporated herein by reference in its entirety.

What is claimed is:

1. An image forming apparatus comprising:
a display section for displaying an initial screen for performing function selection, and a setting screen for performing a setting input of an image forming condition, the setting screen being displayed by performing the function selection a plurality of times from the initial screen,
wherein a short cut button for displaying the setting screen is displayed on the initial screen after when the setting input of the image forming condition is performed on the setting screen.

2. The image forming apparatus of claim 1, wherein image formation is performed by using image data, and the image forming condition is an image processing condition corresponding to the image data.

3. The image forming apparatus of claim 1, wherein the image forming condition is a post-processing condition.

4. The image forming apparatus of claim 1, wherein the plurality of short cut buttons are displayed in a list.

5. The image forming apparatus of claim 4, wherein the plurality of short cut buttons are displayed in a list according to a frequency of use.

6. The image forming apparatus of claim 1, wherein the plurality of short cut buttons are displayed in a condition that the plurality of short cut buttons are capable of being scrolled or turned over.

7. The image forming apparatus of claim 1, wherein information relating to a set content of the short cut button is displayed on the initial screen.

8. The image forming apparatus of claim 7, wherein the set content of the short cut button is the selected function.

9. The image forming apparatus of claim 7, wherein the set content of the short cut button is the image forming condition of which the setting input is performed.

10. The image forming apparatus of claim 1, further comprising a memory for storing screen information of a screen at a time of performing the setting input of the image forming condition.

11. The image forming apparatus of claim 10, wherein a read button for reading out the screen information stored in the memory is displayed on the initial screen.

12. An image forming condition displaying method, comprising:
displaying an initial screen for performing function selection;
displaying a setting screen for performing a setting input of an image forming condition by performing the function selection a plurality of times from the initial screen; and
displaying a short cut button for displaying the setting screen on the initial screen when the setting input of the image forming condition is performed on the setting screen.

13. The image forming condition displaying method of claim 12, wherein in the displaying of the short cut button, the short cut buttons are displayed in a list.

14. The image forming condition displaying method of claim 12, wherein in the displaying of the short cut button, an area where the short cut button is displayed is displayed in a condition that the area is capable of being scrolled or turned over.

15. The image forming condition displaying method of claim 12, wherein in the displaying of the short cut button, information relating to a set content of the short cut button is displayed with the short cut button.

16. The image forming condition displaying method of claim 15, wherein the set content of the short cut button is the selected function.

17. The image forming condition displaying method of claim 15, wherein the set content of the short cut button is the image forming condition of which the setting input is performed.

18. The image forming condition displaying method of claim 12, wherein screen information of the setting screen at a time that the setting input of the image forming condition is performed, is stored in a memory.

19. The image forming condition displaying method of claim 18, wherein on the initial screen, display is performed according to the screen information stored in the memory.
